(19) United States
(12) Patent Application Publication
(10) Pub. No.: US 2006/0186778 A1
(43) Pub. Date: Aug. 24, 2006

(54) Plasma display panel

(76) Inventors: Hun-Suk Yoo, Cheonan-si (KR); Won-Ju Yi, Asan-si (KR); Kyoung-Doo Kang, Seoul (KR)

Correspondence Address: Robert E. Bushnell, Suite 300, 1522 K Street, N.W., Washington, DC, 20005, US

(21) Appl. No.: 11/402,988

(22) Filed: Apr. 13, 2006

Related U.S. Application Data
(63) Continuation-in-part of application No. 10/996,041, filed on Nov. 24, 2004.

(30) Foreign Application Priority Data
Nov. 29, 2003 (KR) 10-2003-0086069

(51) Int. Cl. H01J 31/14

(52) U.S. Cl. 313/3

(57) ABSTRACT

A plasma display panel capable of being fast driven with low voltage by reducing a distance between an address electrode and a Y electrode. The plasma display panel includes a pair of substrates, barrier ribs, discharge electrodes, and an address electrode. The substrates are arranged at a predetermined interval to face each other and form a plurality of discharge spaces between facing surfaces of the substrates. The barrier ribs are arranged between the substrates to partition a space between the substrates into a plurality of discharge cells each having a horizontal cross-section of a circle or an oval. The discharge electrodes are arranged at predetermined intervals between the substrates. The address electrode is arranged a predetermined distance apart from the discharge electrodes in a substrate direction.

### CROSS-REFERENCE TO RELATED APPLICATIONS

This application is a Continuation-in-Part of U.S. patent application Ser. No. 10/996,041 entitled PLASMA DISPLAY PANEL, filed 24 Nov. 2004 in the U.S. Patent & Trademark Office.

### CLAIM OF PRIORITY

This application makes reference to, incorporates the same herein, and claims all benefits accruing under 35 U.S.C. §119 from an application for PLASMA DISPLAY PANEL earlier filed in the Korean Intellectual Property Office on 29 Nov. 2003 and thereby duly assigned Ser. No. 2003-86069.

### BACKGROUND OF THE INVENTION

1. Field of the Invention

The present invention relates to a plasma display panel, and more particularly, to a design for a plasma display panel that is capable of being driven using only low voltages at a high speed by reducing a distance between an address electrode and a Y electrode.

2. Description of the Related Art

A plasma display panel (PDP) display, which is a recent flat panel display, has excellent characteristics, such as the display of a quality image, being extremely thin and light, providing a wide viewing angle while having a large screen. In addition, a PDP display can be more simply manufactured than other flat panel display devices, and be easily enlarged, such that the PDP display is spotlighted as a next-generation flat panel display device.

Turning now to FIGS. 1 and 2, FIGS. 1 and 2 are views of panel 1 of FIGS. 1 and 2 of U.S. Pat. No. 6,657,397 to Lee et al. FIG. 1 is an internal perspective view of the 3-electrode surface discharge PDP 1 and FIG. 2 is a cross-section of a unit display cell of the panel 1 of FIG. 1. Referring to FIGS. 1 and 2, address electrode lines AR1, AG1, . . . , AGm, and ABm, front and rear dielectric layers 11 and 15, Y electrode lines Y1, . . . , and Yn, X electrode lines X1, . . . , and Xn, phosphor layer 16, barrier ribs 17, and a MgO protective layer 12 are arranged between front and rear glass substrates 10 and 13 of the typical 3-electrode surface discharge PDP 1.

The address electrode lines AR1, AG1, . . . , AGm, and ABm are arranged in a predetermined pattern on rear glass substrate 13. The rear dielectric layer 15 covers the address electrode lines AR1, AG1, . . . , AGm, and ABm. The barrier ribs 17 are formed on the front surface of the rear dielectric layer 15 to be parallel to the address electrode lines AR1, AG1, . . . , AGm, and ABm. The barrier ribs 17 define discharge areas of each discharge cell and prevent optical crosstalk between adjacent discharge cells. The phosphor layers 16 are coated between barrier ribs 17.

The X electrode lines X1, . . . , and Xn and the Y electrode lines Y1, . . . , and Yn are patterned on a rear surface of the front glass substrate 10 in a direction that is orthogonal to the address electrode lines AR1, AG1, . . . , AGm, and ABm. The respective intersections define corresponding discharge cells. The X electrode lines X1, . . . , and Xn and the Y electrode lines Y1, . . . , and Yn each have a transparent electrode line made of a conductive material, such as, indium tin oxide (ITO), and a metal electrode line of high conductivity. For example, as illustrated in FIG. 2, the X electrode line Xn is made out of a transparent electrode line Xna and a metal electrode line Xnb, and the X electrode line Yn is made up of a transparent electrode line Yna and a metal electrode line Ynb. The front dielectric layer 11 is entirely coated over the X electrode lines X1, . . . , and Xn and the Y electrode lines Y1, . . . , and Yn. The MgO protective layer 12 for protecting the panel 1 against strong electric fields is coated over the entire rear surface of the front dielectric layer 11. Discharge spaces 14 are sealed with a gas for forming plasma.

As illustrated in FIG. 1, in the 3-electrode surface discharge PDP 1, not only the X electrode lines X1, . . . , and Xn, the Y electrode lines Y1, . . . , and Yn are formed on the rear surface of the front substrate, but also the dielectric layer 11 and the protective layer 12 are formed on the front glass substrate 10 over the X and Y electrodes. During discharge, visible rays emitted from the phosphors 16 in the discharge spaces 14 pass through the front substrate 10. However, the 3-electrode surface discharge PDP 1 has a significant problem in that only about 60% of the visible rays are transmitted through the front substrate 10 because of various components formed on the front substrate 10.

In the 3-electrode surface discharge PDP 1, electrodes that cause the discharge are formed over the discharge spaces 14, namely, on the inner or rear surface of the front substrate 10 through which the visible rays pass, such that the discharge is generated on the inner surface thereof and spreads. Hence, the 3-electrode surface discharge PDP 1 has low luminescent efficiency. These electrodes formed on the inner surface of the front substrate tend to block some of the visible rays generated, thus leading to losses. Further, when the 3-electrode surface discharge PDP 1 is used for a long period of time, charged particles of a discharge gas cause ion sputtering of the phosphor layers due to an electric field, thus generating a permanent residual image.

Furthermore, in the 3-electrode surface discharge PDP 1 of FIG. 1, the address electrode AGm is formed on the rear glass substrate 13 to have a distance of about 130 to 160 μm from the X and Y electrode lines Xn and Yn on the front substrate 10. Accordingly, an address voltage of 60 to 80V is applied to an address electrode that is arranged in a discharge cell to be selected during an addressing period, and a scan voltage of −60 to −80V is applied to a Y electrode that is arranged in the discharge cell to be selected during the addressing period. In other words, a great distance between the address electrode and the Y electrode requires a very large voltage, which requires high power consumption.

As illustrated in FIG. 1, a distance between an address electrode and a Y electrode depends on a height hw of each of the barrier ribs 17. When the height hw of each of the barrier ribs 17 is decreased to enhance address discharge characteristics, the overall brightness of the panel 1 is reduced due to a decrease in the amount of to-be-coated phosphor. In other words, when the height hw of each of the barrier ribs 17 is decreased by about 10 cm, the overall brightness of the panel 1 is reduced about 5 to 10%. Thus, attempts to lower power consumption by reducing barrier rib height can deteriorate the image quality. If the barrier ribs are made shorter to lower the power consumption, brightness suffers. If the barrier ribs are made high, the distance between the address and the Y electrodes increase leading to higher power consumption.

### SUMMARY OF THE INVENTION

It is therefore an object of the present invention to provide an improved design for a PDP.

It is also an object to provide a design for a plasma display panel that is capable of being driven with low voltage and at high speed by reducing a distance between an address electrode and a Y electrode without decreasing the distance between the substrates.

It is further an object of the present invention to provide a design for a PDP where a gap between the address electrodes and the discharge electrodes is reduced without incurring any degradation in image quality.

These and other objects can be achieved by a plasma display panel including a front substrate and a rear substrate arranged at an interval to face each other, a plurality of barrier ribs arranged between the front and the rear substrates, the plurality of barrier ribs being adapted to partition a space between the front and the rear substrates into a plurality of discharge cells, each of said plurality of discharge cells having one of a circular and an oval horizontal cross-section, a plurality of discharge electrodes arranged at intervals on the plurality of barrier ribs in a substrate direction going from the front substrate to the rear substrate and a plurality of address electrodes arranged a distance apart from the plurality of discharge electrodes in the substrate direction.

The plurality of discharge electrodes and the plurality of address electrodes can be arranged on surfaces of the plurality of barrier ribs that face the plurality of discharge cells.

The plasma display panel can further include a dielectric layer coated over surfaces of the plurality of barrier ribs where the plurality of discharge electrodes and the plurality of address electrode are arranged, the dielectric layer being adapted to prevent charges from moving directly between the plurality of discharge electrode and the plurality of address electrodes.

According to another aspect of the present invention, there is provided a plasma display panel including a front substrate and a rear substrate arranged at an interval to face each other, a plurality of barrier ribs arranged between the front and the rear substrates, the plurality of barrier ribs being adapted to partition a space between the front and the rear substrates into a plurality of discharge cells, each of the plurality of discharge cells having one of a circular and an oval cross-section, a plurality of upper sidewalls extending from the plurality of barrier ribs towards the front substrate, a plurality of discharge electrodes arranged at intervals and within the plurality of upper sidewalls, the plurality of discharge electrodes being arranged in a substrate direction going from the front substrate to the plurality of barrier ribs and a plurality of address electrodes arranged a distance apart from the plurality of discharge electrodes in the substrate direction.

The plurality of upper sidewalls can include a dielectric material, the plurality of discharge electrodes being arranged within the upper sidewalls, the plasma display panel can further include a protective layer arranged on the upper sidewalls and adapted to protect the plurality of upper sidewalls.

The plurality of address electrodes can be arranged within the plurality of upper sidewalls.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate same or similar components, wherein:

FIG. 1 is an internal perspective view of a conventional 3-electrode surface discharge plasma display panel (PDP);

FIG. 2 is a cross-section of a unit display cell of the PDP of FIG. 1;

FIG. 3 is an exploded perspective view of a part of a PDP according to an embodiment of the present invention;

FIG. 4 is a cross-section of a single discharge space of the PDP of FIG. 3;

FIG. 5 is a cross-section cut along line V-V of FIG. 4;

FIG. 6 is a plan view illustrating a configuration of discharge electrodes illustrated in FIG. 3; and

FIGS. 7 through 14 are cross-sections of a single discharge space of PDPs according to other embodiments of the present invention.

FIG. 15 is an exploded perspective view of a part of a PDP according to another embodiment of the present invention;

FIG. 16 is a cross-section of a single discharge space of the PDP of FIG. 15;

FIG. 17 is a perspective view of a part of electrodes of the PDP of FIG. 15;

FIG. 18 is an exploded perspective view of a part of a PDP according to another embodiment of the present invention; and

FIG. 19 is a cross-section of a single discharge space of the PDP of FIG. 18.

### DETAILED DESCRIPTION OF THE INVENTION

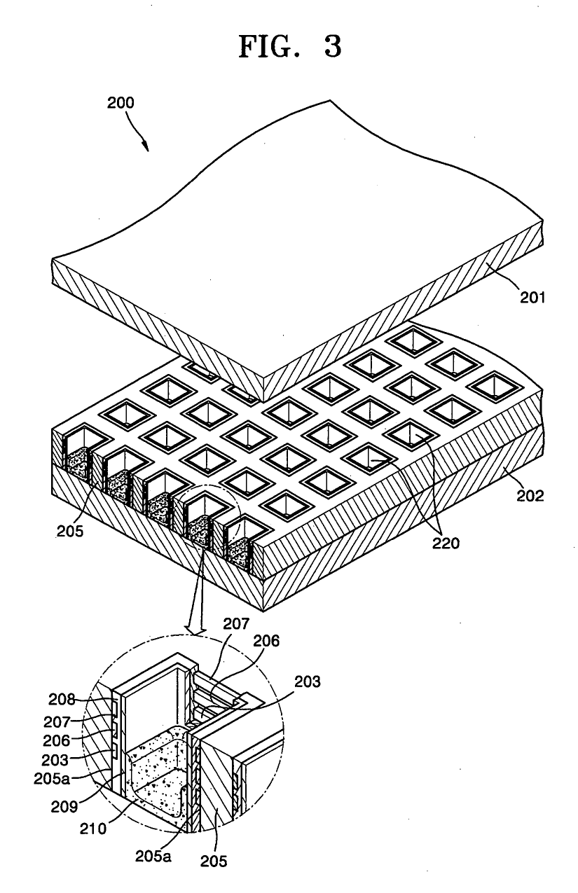

Turning now to FIGS. 3 through 8, these figures illustrate PDPs 200, 300 and 400 according to embodiments of the present invention. Referring to FIG. 3, a plasma display panel 200 according to an embodiment of the present invention includes a front substrate 201 facing a rear substrate 202 and spaced apart from each other by a predetermined distance. Barrier ribs 205 divide a space between the substrates into a plurality of discharge spaces 220. The barrier ribs 205 may be arranged in various patterns as long as the discharge spaces 220 can be formed. For example, the barrier ribs 205 may be not only open barrier ribs, such as strips, but also closed barrier ribs, such as ribs forming a waffle, a matrix, a delta shape, or the like. In FIGS. 3 through 8, the barrier ribs are illustrated as being closed barrier ribs, and the closed barrier ribs 205 are formed such that each of the discharge spaces 220 has a rectangular horizontal cross-section. However, the horizontal cross-section of each of the discharge spaces 220 can instead be polygonal (e.g., triangular, pentagonal, or the like), circular, oval, or the like.

The barrier ribs 205 define discharge spaces and also serve as a base to support the discharge electrodes 206 and 207. Accordingly, the barrier ribs 205 may be formed in any shape as long as the discharge electrodes 206 and 207 can be arranged so that discharge is initiated and spreads. For example, a lateral side (or barrier rib sidewall) 205a of each of the barrier ribs 205 may extend either perpendicularly to the front substrate 201 or aslant with respect to the direction perpendicular to the front substrate 201. Alternatively, the barrier sidewalls 205a may be curved in such a way that one end extends aslant in one direction and the other end extends aslant in the opposite direction.

Depending on various shapes of the barrier ribs 205, the discharge electrodes 206 and 207 may be arranged in various patterns on the barrier rib sidewalls 205a of barrier ribs 205. Various types of discharge can start and spread depending on various shapes of a discharge surface formed by the discharge electrodes 206 and 207. To apply a voltage that selects a discharge space 220 where discharge is to start, address electrodes 203 maybe arranged in a predetermined pattern, for example, in a striped pattern on the rear substrate 202 such as to correspond to each of the discharge spaces 220. The pattern of the address electrodes 203 is not limited to the striped pattern but may have various other shapes depending on the shape of the discharge spaces 220.

Although the address electrodes 203 may be arranged on the rear substrate 202, they may be arranged at a different suitable location, such as, on the front substrate 201, on the barrier ribs 205, and the like. The address electrodes 203 may be unnecessary because the voltage that selects the discharge space 220 where discharge is to start can be applied to a space between the discharge electrodes 206 and 207 by appropriately arranging the discharge electrodes 206 and 207, for example, by crossing them. As illustrated in FIG. 3, the address electrodes 203 are not arranged on the rear substrate but are arranged on the sidewalls of the barrier ribs 205 along with the discharge electrodes, and spaced a predetermined distance apart from the discharge electrodes 206 and 207 on the barrier ribs 205. In the present embodiment, a rear dielectric layer is optional. However, a rear dielectric layer formed on a rear substrate may be included as in a PDP.

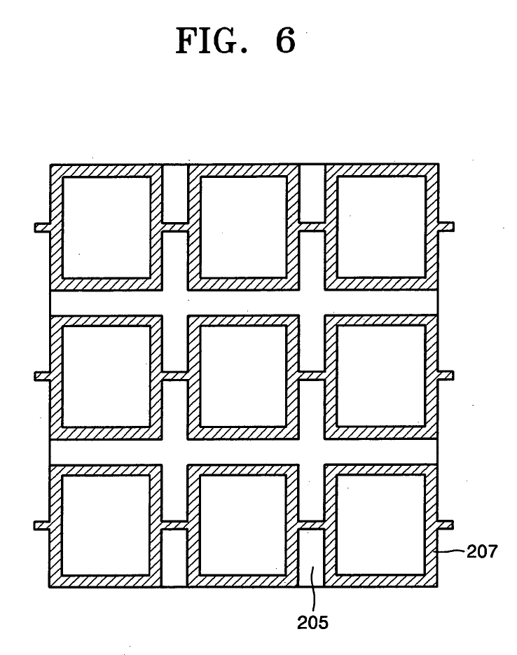

As illustrated in FIGS. 3 through 6, electrodes that initiate discharge in the discharge spaces 220, for example, the discharge electrodes 207 and 206 (hereinafter, referred to as X electrodes and Y electrodes), are formed on the barrier ribs 205. The X and Y electrodes 207 and 206 are arranged such that discharge due to a difference between voltages applied to the X and Y electrodes 207 and 206 can start on surfaces of the barrier ribs 205 between the X and Y electrodes 207 and 206. Although the X and Y electrodes 207 and 206 are formed on the barrier ribs 205 in the present embodiment, the X and Y electrodes 207 and 206 may be arranged in various patterns and on various locations as long as a surface discharge can occur in the discharge spaces 220 defined by the X and Y electrodes 207 and 206. For example, as illustrated in FIG. 6, the X and Y electrodes 207 and 206 may each have a shape of a rectangular ring and be arranged parallel to each other around the barrier rib sidewalls 205a.

The X and Y electrodes 207 and 206 need to be separated from each other by enough distance so that surface discharge can start and spread. However, it is preferable to decrease the distance between the X and Y electrodes 207 and 206 as much as possible, because by doing so, only a low driving voltage is necessary, thus reducing power. Although each of the X and Y electrodes 207 and 206 is illustrated to have a ring shape in FIGS. 3 through 6, the barrier ribs may instead have various other shapes and are in no way limited to just the ring shape. Also, although the X and Y electrodes 207 and 206 may be arranged in various patterns, it is preferable that they are arranged such that discharge can be easily initiated and spread even when a low voltage is applied.

For example, to widen a discharge surface on which discharge occurs by as much as possible, the X and Y electrodes 207 and 206 may be arranged in such a way that ring-shaped Y electrodes 206 are arranged over and under a ring-shaped X electrode 207, respectively, or that ring-shaped X electrodes 207 are arranged over and under a ring-shaped Y electrode 206, respectively. Due to these arrangements, an effect that a discharge surface is enlarged in a height direction of the discharge spaces 220 can be obtained. In this case, to lower an address voltage to be applied between an address electrode 203 and a Y electrode 206, the Y electrode 206 is preferably arranged close to the address electrode 203, that is, close to the rear substrate 202.

The X and Y electrodes 207 and 206 may be arranged so that facing parts of the X and Y electrodes 207 and 206 are arranged on a side or lateral surface of the discharge space 220 so that the gap between these two electrodes is perpendicular to the front substrate 201. In other words, the X electrode 207 is located on the lateral surface of the discharge space 220, and Y electrodes 206 is located on both sides of the X electrode 207 and spaced from the X electrode 207 by a predetermined distance so that facing parts of the X and Y electrodes 207 and 206 are perpendicular to the front substrate 201. In this case, it is preferable that the discharge electrodes 206 and 207 are arranged so that discharge electrodes on a lateral surface of the discharge space 220 are symmetrical to those on an adjacent lateral surface thereof

Due to this arrangement of the discharge electrodes 206 and 207, an effect in which the discharge surface is extended in a circumferential direction of the discharge spaces 220 can be obtained. Besides, the discharge electrodes 206 and 207 may have other shapes and can be arranged in other patterns. The X and Y electrodes 207 and 206 may be formed using various methods, for example, a printing method, a sandblasting method, a deposition method, and the like. Preferably, the X and Y electrodes 207 and 206 are all arranged over the barrier ribs 205.

As illustrated in FIG. 3, the X and Y electrodes 207 and 206 are preferably arranged so that a part of a lateral (or sidewall) dielectric layer 208 can exist between the X and Y electrodes 207 and 206 to maintain insulation between the X and Y electrodes 207 and 206. It is also preferable that the lateral dielectric layer 208 is formed on the sidewalls 205a of barrier ribs 205 and to cover the X and Y electrodes 207 and 206.

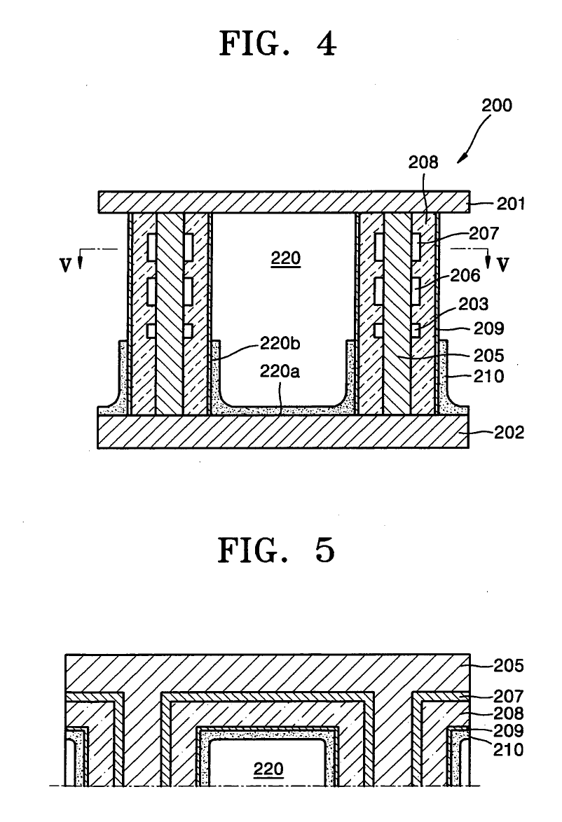

Preferably, a protective layer 209, for example, an MgO layer, is formed on the lateral dielectric layer 208 to protect the same. Phosphors 210, which emit visible rays when excited by ultraviolet rays generated from a discharge gas, are formed in the discharge spaces 220 formed by the lateral dielectric layer 208, the rear dielectric layer 204, and the front substrate 201. The phosphors 210 may be formed at any location on the discharge spaces 220. However, as illustrated in FIGS. 3 and 4, the phosphors 210 are preferably formed on a bottom part of the discharge spaces 220 that is close to the rear substrate 202, so as to cover bottom surfaces 220a of the discharge spaces 220 and lower parts of lateral (or sidewall) surfaces 220b thereof.

A discharge gas, such as, Ne, Xe, or a mixture of Ne and Xe, or the like, is sealed in each of the discharge spaces 220. In the plasma display panel 200 according to the present embodiment, the amount of plasma formed increases due to an increase in a discharge surface and an extension of a discharge area, so that the panel 200 can be driven with low voltage. Hence, the plasma display panel 200 can be driven with low voltage, even when a high-concentration Xe gas is used as a discharge gas, thus increasing luminance efficiency greatly.

A Xe partial pressure in a discharge gas needs to be increased to drive a PDP with high efficiency. However, when the Xe partial pressure increases within the discharge gas, an address discharge margin is apt to decrease. To counter this decrease in the address discharge margin brought on by the increase in Xe partial pressure, the address discharge margin can be increased by reducing a distance between an address electrode and a Y electrode. By doing so, the partial pressure of Xe in the discharge gas can be kept high without the address discharge margin falling to unacceptably low levels. Thus, even when the Xe partial pressure within the discharge gas increases, the PDP can be effectively used. This feature of the present embodiment solves a problem of having a high Xe partial pressure without requiring a high driving voltage. In other words, by designing the PDP as so, the PDP can have both a high Xe partial pressure and drive at low voltages.

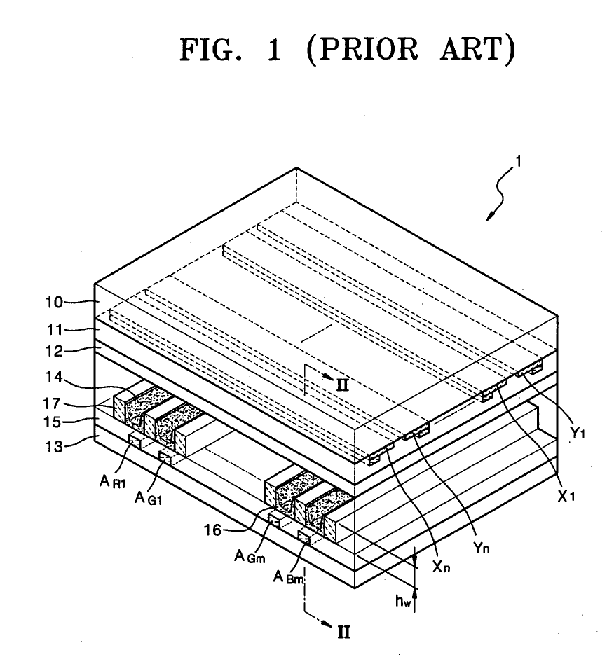

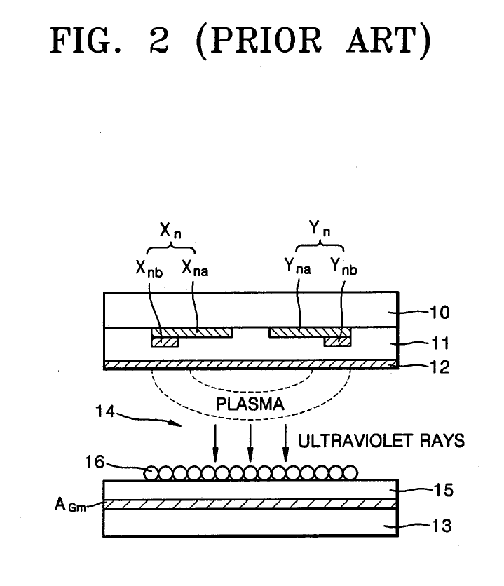

An upper opening of each of the discharge spaces 220 is enclosed by the front substrate 201. The front substrate 201 does not include indium tin oxide (ITO) discharge electrodes, bus electrodes, and a dielectric layer that a front substrate of the conventional PDP 1 of FIG. 1 included. In the plasma display panel 200 according to the present embodiment, the losses in visible light transmission through the front substrate 201 is significantly reduced thus increasing greatly the transmittance of visible rays through the front substrate to 90%. This improved front substrate transmittance further allows a low driving voltage for the electrodes. Thus, the panel 200 can be driven with low voltage, consequently maximizing luminance efficiency. The front substrate 201 may be formed of any material as long as the material is transparent. For example, the front substrate 201 may be formed of glass.

Discharge occurring during a sustain discharge period when the PDP 200 illustrated in FIGS. 3 through 6 is driven will now be described. First, when a predetermined address voltage received from an external power source is applied between the address electrodes 203 and the Y electrodes 206, a discharge space 220 to emit light is selected, and wall charges are accumulated near the Y electrode 206 of the selected discharge space 220. Then, when a positive voltage is applied to an X electrode 207 of the selected discharge space 220 and a voltage lower than the positive voltage is applied to the Y electrodes 206, wall charges are moved due to a difference between voltages applied to the X and Y electrodes 207 and 206. The moving wall charges collide with discharge gas atoms located within the selected discharge space 220, thus producing discharge and generating plasma. This discharge is highly likely to occur in a space between the X and Y electrodes 207 and 206 where a strong electrical field is formed.

In the present embodiment, the space between the X and Y electrodes 207 and 206 exists on four lateral (or side) surfaces of the discharge space 220, so that the possibility that discharge occurs is drastically increased compared with the conventional art of PDP 1 of FIG. 1 where a space between discharge electrodes exist only on an upper surface of a discharge space. When the sufficiently big difference between voltages applied to X and Y electrodes is kept even when time lapses, electrical fields formed between the X and Y electrodes are concentrated near the lateral surfaces of the discharge space 220 to produce a strong electrical field. Then, discharge is spread to the entire discharge space 220. The discharge in the present embodiment has a ring shape and occurs on the four lateral surfaces of the discharge space 220. The ring-shaped discharge is eventually spread to the center of the discharge space 220. On the other hand, in PDP 1 of FIG. 1, a discharge occurs from only an upper surface of a discharge space and is spread to the center of the discharge space from this upper surface. Therefore, the discharge in the present embodiment is far more effective than the discharge in conventional PDP 1 of FIG. 1.

The plasma produced due to the discharge in the present embodiment is also formed in the shape of a ring around the four lateral surfaces of the discharge space 220 and spreads to the center of the discharge space 220, so that the plasma is sharply enlarged, resulting in a drastic increase in the amount of visible light produced. Due to the spread of the plasma to the center of the discharge space 220, space charges can be utilized to thus enable the PDP in the present embodiment to be driven with low voltage and to increase luminance efficiency.

Since the plasma is concentrated at the center of the discharge space 220 and electrical fields generated by the discharge electrodes 206 and 207 exist on four lateral surfaces of the discharge space, charges are collected at the center of the discharge space 220 and can prevent ion sputtering of the phosphor layer 210 coated in the discharge space 220.

When such discharge is formed and the difference between the voltages applied to the X and Y electrodes 207 and 206 is lower than a discharge voltage, no more discharging occurs, and space charges and wall charges are formed in the discharge space 220. At this time, when the polarities of the voltages applied to the X and Y electrodes 207 and 206 are toggled, a new discharge occurs with the help of the wall charges. Thereafter, the discharge spreads to the entire discharge space 220 and then disappears.

When the polarities of the voltages applied to the X and Y electrodes 207 and 206 are toggled or re-switched with each other again, the initial discharge process resumes. By repeating this process, a stable discharge results. However, the discharge in the present embodiment does not limit the scope of the present invention, and various types of discharge may be used by those of ordinary skill in the art and still be within the scope of the present invention.

Referring to FIG. 3, the PDP 200 includes a front and a rear substrate 201 and 202, at least one barrier rib 205, the discharge electrodes (Y and X electrodes) 206 and 207, the address electrodes 203, the lateral dielectric layer 208, a protective layer 209, and the phosphor layer 210. The front and rear substrates 201 and 202 face each other and are separated from each other by a predetermined distance. The barrier ribs 205 define a plurality of discharge spaces 220 in a space between the front and rear substrates 201 and 202.

The Y electrodes 206 cause an address discharge in spaces between the Y electrodes 207 and the address electrodes 203 and select a particular discharge space from the discharge spaces 220. The X electrodes 207 cause a sustain discharge between the X electrodes 207 and the Y electrodes 206. The discharge electrodes 206 and 207 are arranged in parallel on the barrier ribs 205 in a substrate direction going from the front substrate 201 to the rear substrate 202, to be a predetermined distance away from each other. The substrate direction is a direction that is substantially perpendicular or normal to the surface of the substrate. Preferably, the discharge electrodes 206 and 207 and the address electrodes 203 are arranged on surfaces of each of the barrier ribs 205 that face each of the discharge space 220.

The address electrodes 203 are arranged at a predetermined distance apart from the discharge electrodes 206 and 207 in the substrate direction, thus defining the discharge spaces 220 together with the discharge electrodes 206 and 207. As illustrated in FIG. 6, when the address electrodes 203 are arranged to be orthogonal to the discharge electrodes 206 and 207, scan pulses are applied to Y electrodes 206 in a sequence where the Y electrodes 206 are arranged, and an address voltage is applied to an address electrode 203 corresponding to a discharge cell, thus selecting the discharge cell to emit light.

The lateral dielectric layer 208 is coated over the barrier rib 205 on which the discharge electrodes 206 and 207 and the address electrode 203 are arranged. The protective layer 209 is formed on the lateral dielectric layer 208 to protect the lateral dielectric layer 208. The phosphor layer 210 is coated within each of the discharge spaces 220.

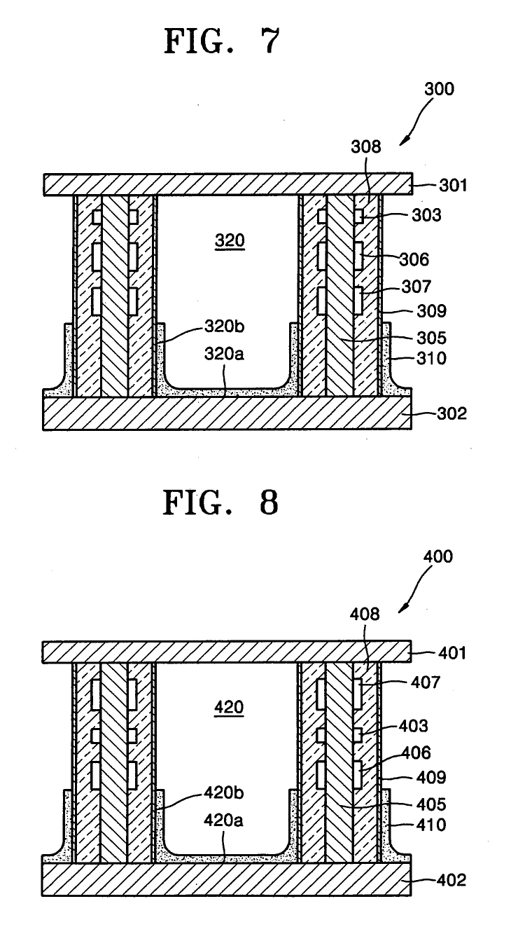

In the PDP 200 of FIG. 4, the X electrode 207 is positioned closest to the front substrate 201, then the Y electrode 206 and then address electrode 203 is located closest to the rear substrate 202. In a PDP 300 of FIG. 7, the relative positioning of these three electrodes is changed so that the order from top to bottom is the address electrode 303, the Y electrode 306 and lastly the X electrode 307 are each arranged on a barrier rib 305. In a PDP 400 of FIG. 8, the X electrode 407 is placed closest to the front substrate 401, then the address electrode 403 and lastly the Y electrode 406 is located further from the front substrate 401 than either the address electrode or the X electrode 407. In these embodiments, an address electrode and a Y electrode are arranged in parallel and adjacent to each other to reduce the distance between the address electrode and the Y electrode.

In the PDP 200 of FIG. 4, the X electrode 207, the Y electrode 206, and the address electrode 203 are sequentially arranged on surfaces of the barrier rib 205 that face a discharge space 220 in a direction going from the front substrate 201 to the rear substrate 202. In the PDP 300 of FIG. 7, the address electrode 303, the Y electrode 306, and the X electrode 307 are sequentially arranged on surfaces of the barrier rib 305 that face a discharge space 320, in a direction going from a front substrate 301 to a rear substrate 302.

In the PDP 400 of FIG. 8, the X electrode 407, the address electrode 403, and the Y electrode 406, and the address electrode 403 are sequentially arranged on surfaces of the barrier rib 405 that face a discharge space 420, in a direction going from a front substrate 401 to a rear substrate 402. Alternatively, the X electrode 407, the Y electrode 406, and the address electrode 403 may be arranged in a sequence from the Y electrode 406 to the X electrode 407 via the address electrode 403. In other words, the order of positioning of the X, Y and address electrodes on the sidewalls of the barrier ribs can be changed. One design consideration is that the Y electrode and the address electrode are preferably positioned adjacent to each other as opposed to opposite from each other.

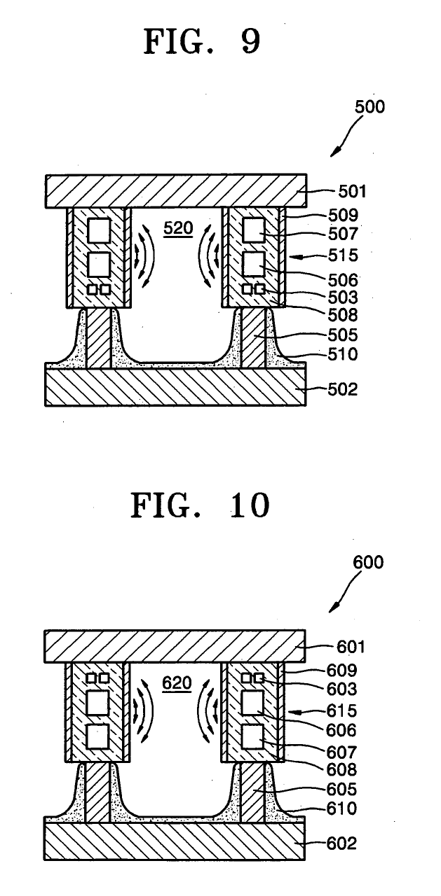

Turning now to FIGS. 9 through 14, FIGS. 9 through 14 are cross-sections of a single discharge space of PDPs 500, 600, 700, 800, 900, and 1000 according to other embodiments of the present invention. The embodiments of FIGS. 9 through 14 are similar to the above-described embodiments in that an address electrode and discharge electrodes are not formed on the substrates but on a sidewall of a structure between the substrates so that a distance between the address electrode and the Y electrode can be lowered without compromising image quality or luminance, thus resulting in a highly efficient address discharge possible using small voltages. Hence, the same features as those in previously described PDPs 200, 300 and 400 will not be repeated here in detail.

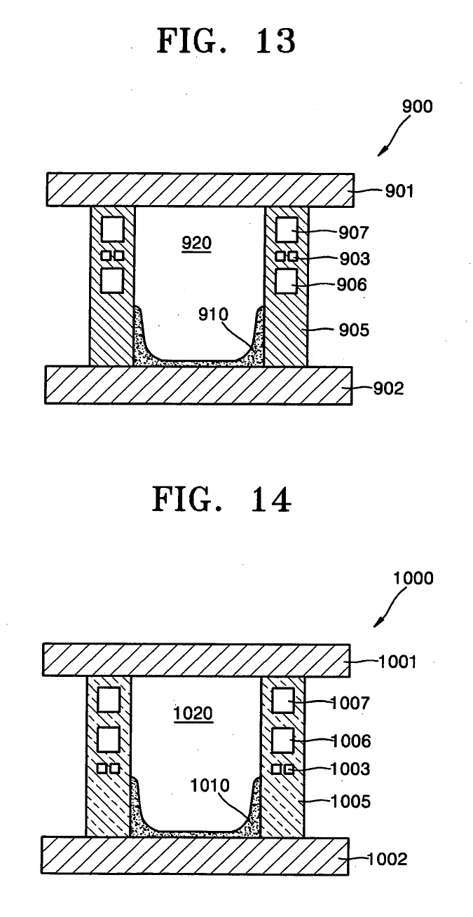

In PDPs 500, 600, 700 and 800 of FIGS. 9 through 12, a combination of barrier ribs and upper sidewalls are arranged between the two substrates. In these embodiments, the discharge electrodes and the address electrodes are arranged within the upper sidewalls and not in or on the barrier ribs. The PDPs 500, 600 and 700 of FIGS. 9 through 11 further include upper sidewalls 515, 615 and 715, respectively, extending from barrier ribs 505, 605 and 705, respectively, between a barrier rib 505 and a front substrate 501, between a barrier rib 605 and a front substrate 601, and between a barrier rib 705 and a front substrate 701, respectively. As in the PDPs of FIGS. 4, 7 and 8, the PDPs of FIGS. 9, 10 and 11 vary only in order of electrodes in the upper sidewalls. In the PDP 500, a Y electrode 506, an X electrode 507, and an address electrode 503 are arranged within the upper sidewall 515. In the PDP 600, a Y electrode 606, an X electrode 607, and an address electrode 603 are arranged within the upper sidewall 615. In the PDP 700, a Y electrode 706, an X electrode 707, and an address electrode 703 are arranged within the upper sidewall 715. In the PDP-800, the address electrodes are arranged in the barrier ribs while the discharge electrodes are arranged in the upper sidewalls. Two address electrodes 503, two address electrodes 603, and two address electrodes 703 are arranged within the upper sidewalls 515, 615, and 715, respectively, in parallel to the substrates so that discharge spaces 520, 620, and 720 can each be selected. However, in the embodiment of FIG. 12, two address electrodes 803 are arranged within a barrier rib 805 instead of within the upper sidewall 815 so that a discharge space 820 can be selected.

In other words, in these embodiments of FIGS. 9 through 12, the barrier ribs do not entirely fill the gap between the two substrates. Instead, they only partially fill the gap, the remainder of the gap being filled in by the upper sidewalls. Thus, the combination of the upper sidewalls and the barrier ribs account for the entire gap between the two substrates. In addition, the discharge spaces are surrounded by the combination of the barrier ribs and the upper sidewalls, not just the barrier ribs only.

In addition, in the embodiments of FIGS. 9 through 11, the address electrodes and the discharge electrodes are embedded within or arranged within these upper sidewalls and not within the barrier ribs. Further, the address electrodes are split into two strands instead of one. FIGS. 9, 10 and 11 differ from each other merely in the relative positioning of the X, Y and address electrodes from each other as in the case of FIGS. 4, 7 and 8. In the case of FIG. 12, only the discharge electrodes are arranged within the upper sidewalls while the address electrodes are arranged within the barrier ribs.

Turning now to FIGS. 13 and 14, unlike the embodiments of FIGS. 4, 7 and 8, the discharge electrodes and the address electrodes of FIGS. 13 and 14 are formed within the barrier ribs as opposed to being formed on the barrier ribs. Turning now to FIGS. 13 and 14, in a PDP 900 of FIG. 13, a Y electrode 906, an X electrode 907, and an address electrode 903 are arranged at predetermined intervals within a barrier rib 905 in a substrate direction going from a front substrate 901 to a rear substrate 902 so as to be parallel to one another. In a PDP 1000 of FIG. 14, a Y electrode 1006, an X electrode 1007, and an address electrode 1003 are arranged at predetermined intervals within a barrier rib 1005 in a substrate direction going from a front substrate 1001 to a rear substrate 1002 so as to be parallel to one another. Unlike the embodiments of FIGS. 4, 7 and 8, the electrodes are formed inside and not on the surface of the barrier ribs. In these embodiments, since the Y electrodes 906 and 1006, the X electrodes 907 and 1007, and the address electrodes 903 and 1003 are arranged within and not on the barrier ribs 905 and 1005, the dielectric layer and the protective layers on the lateral walls of the barrier ribs are not necessary for the generation of wall charges. Thus, in the embodiments of FIGS. 13 and 14, no dielectrics for insulating the Y electrodes 906 and 1006, the X electrodes 907 and 1007, and the address electrodes 903 and 1003 from one another are needed.

A Xe partial pressure in a discharge gas needs to be increased to drive a PDP with high efficiency. However, when the Xe partial pressure increases within the discharge gas, an address discharge margin is apt to decrease. To offset this decrease, the address discharge margin can be increased by reducing a distance between an address electrode and a Y electrode. By doing so, the partial pressure of Xe in the discharge gas can be kept high without the address discharge margin falling to unacceptably low levels. Thus, even when the Xe partial pressure within the discharge gas increases, the PDP can be effectively used.

A PDP according to the present invention can be fast driven with low voltage by reducing a distance between an address electrode and a Y electrode. Also, even when a Xe partial pressure within a discharge gas is high, stable address discharge is possible, leading to highly efficient discharge display.

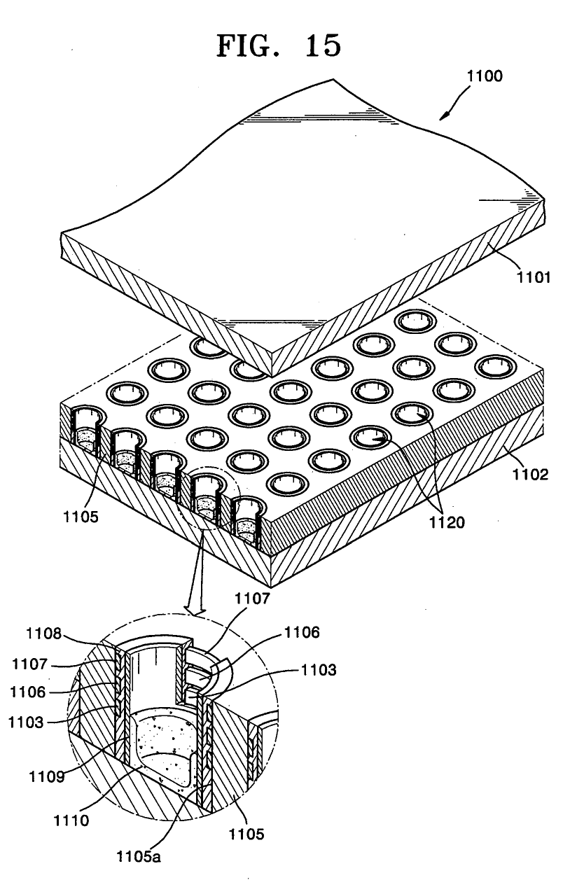

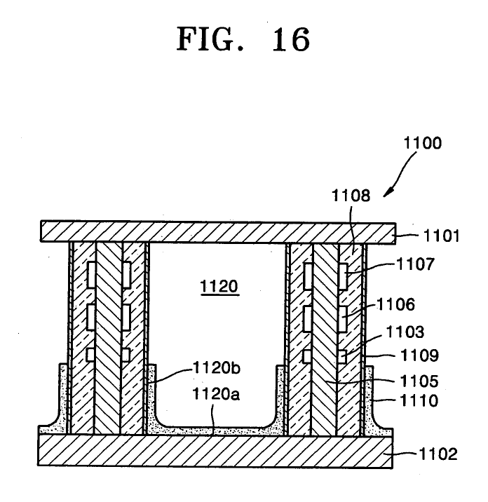

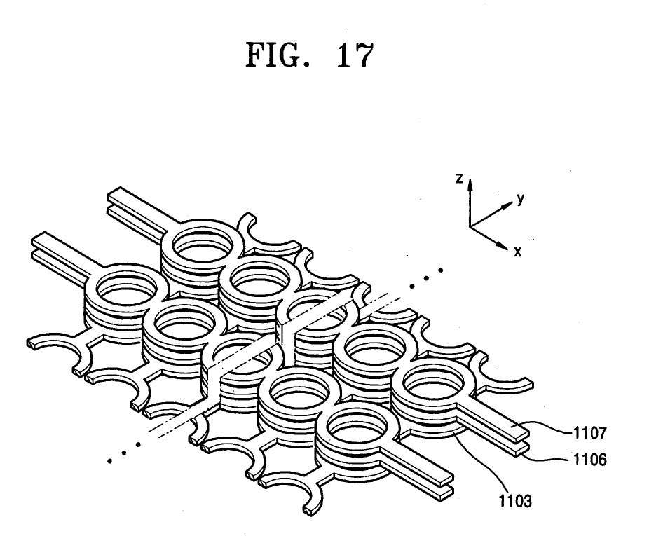

Turning now to FIGS. 15, 16 and 17, FIG. 15 is an exploded perspective view of a part of a PDP 1100 according to another embodiment of the present invention, FIG. 16 is a cross-section of a single discharge cell of the PDP 1100 of FIG. 15 and FIG. 17 is a perspective view of a portion of the electrodes of the PDP 1100 of FIG. 15. Referring to FIGS. 15 through 17, the PDP 1100 includes a front substrate 1101, a rear substrate 1102, barrier ribs 1105, discharge electrodes 1106 and 1107, address electrodes 1103, a dielectric layer 1108, a protective layer 1109, and phosphor layers 1110. The PDP 1100 in the embodiment of FIGS. 15, 16 and 17 has a barrier structure that is similar to that in the PDP 200 of FIG. 3, except that horizontal cross-sections of discharge cells are either circular or oval.

In FIGS. 15, 16 and 17, the front and rear substrates 1101 and 1102 face each other and are spaced apart from each other by a predetermined distance. The barrier ribs 11 05 are arranged between the front and the rear substrates 1101 and 1102 and partition a space between the two substrates into discharge cells 1120. As viewed downward from the front substrate 1101, the discharge cells 1120 are either circular or oval. The discharge electrodes 1106 and 1107 are arranged at predetermined intervals on the barrier ribs in a substrate direction going from the front substrate 1101 to the rear substrate 1102. The address electrodes 1103 are arranged to be spaced a predetermined distance from the discharge electrodes 1106 and 1107 in the substrate direction.

The dielectric layer 1108 is coated over the barrier ribs 1105 having the discharge electrodes 1106 and 1107 and the address electrodes 1103 formed thereon. The protective layer 1109 is formed on the dielectric layer 1108 to protect the dielectric layer 1108. The phosphor layers 1110 are formed by coating phosphor within the discharge cells 1120. Preferably, the phosphor layers 1110 are situated within the discharge cells 1120 away from the address electrodes 1103 and away from the discharge electrodes 1106 and 1107. FIG. 16 illustrates phosphor layers 1110 coating the bottom surface 1120a of discharge cell 1120 over the rear substrate 1102 and on a lower portion of the sidewall surface 11 20b of the discharge cell 1120 over the protective layer 1109.

Each of the discharge electrodes 1 106 and 1107 and the address electrodes 1103 can be arranged at predetermined intervals in a substrate direction going from the front substrate 1101 to the rear substrate 1102. The discharge electrodes 1106 and 1107 and the address electrodes 1103 are preferably arranged on surfaces 1105a of the barrier ribs 1105 that face the discharge cells 1120.

The discharge electrodes 1106 correspond to Y electrodes, and the discharge electrodes 1107 correspond to X electrodes. An address discharge is produced between the Y electrodes 1106 and the address electrodes 1103 to select which discharge cells are to emit light in the subsequent sustain discharge. The sustain discharge is produced between the X electrodes and the Y electrodes 1106. It is preferable that the X electrodes 1107, the Y electrodes 1106, and the address electrodes 1103 are sequentially arranged on surfaces of the barrier ribs 1105 that face the discharge cells 1120, in the direction going from the front substrate 1101 to the rear substrate 1102.

In a variation of the present embodiment of FIGS. 15, 16 and 17, these three sets of electrodes can instead be arranged in some other order, such as that of FIG. 7 where the address electrode 303, the Y electrode 306, and the X electrode 307 are sequentially arranged in the direction from the front substrate 301 to the rear substrate 302.

In still another variation of the present embodiment, these three electrode sets can instead be arranged in the order of FIG. 8 where the X electrode 407 is placed closest to the front substrate 401, then the address electrode 403 and lastly the Y electrode 406 is located furthest from the front substrate 401. In yet another variation of the present embodiment, the relative positioning of these three electrode sets can be changed so that a Y electrode, an address electrode, and an X electrode are sequentially arranged.

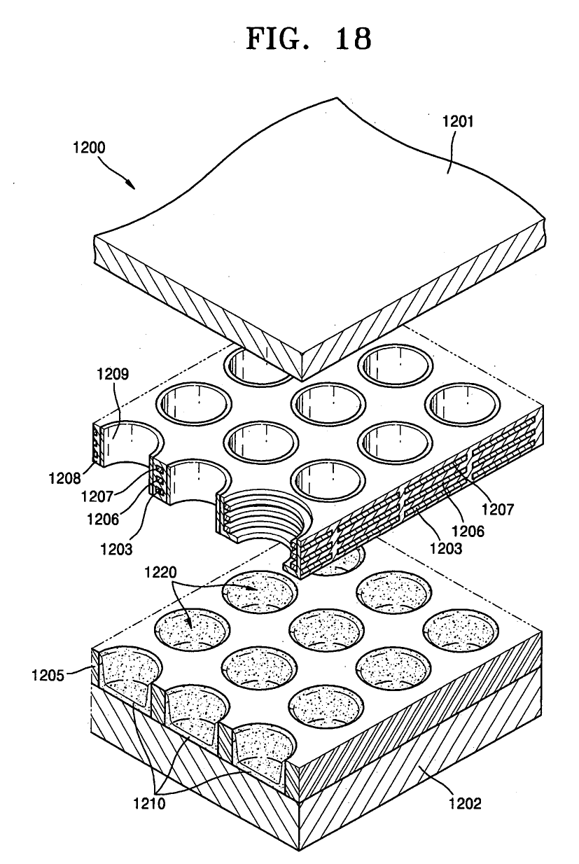

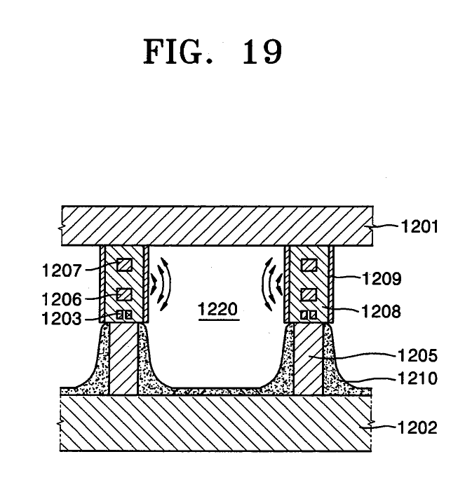

Turning now to FIGS. 18 and 19, FIG. 18 is an exploded perspective view of a part of a PDP 1200 according to another embodiment of the present invention and FIG. 19 is a cross-section of a single discharge cell of the PDP 1200 of FIG. 18. Referring to FIGS. 18 and 19, the PDP 1200 includes a front substrate 1201, a rear substrate 1202, barrier ribs 1205, upper sidewalls 1208, discharge electrodes 1206 and 1207, address electrodes 1203, a protective layer 1209, and phosphor layers 1210. The PDP 1200 in the present embodiment of FIGS. 18 and 19 is similar to the PDP 1100 of FIG. 15 except that the PDP 1200 of FIGS. 18 and 19 further include upper sidewalls 1208 between the barrier ribs 1205 and the front substrate 1201 and the three electrode sets 1203, 1206, and 1207 are located on the upper sidewalls 1208 and not on the barrier ribs 1205.

The front and rear substrates 1201 and 1202 face each other and are spaced apart from each other by a predetermined distance. The barrier ribs 1205 are arranged between the front and rear substrates 1201 and 1202 to partition a space between the two substrates into discharge cells 1220. As viewed downward from the front substrate 1201, the discharge cells 1220 are either circular or oval. The upper sidewalls 1208 extend from the barrier ribs 1205 toward the front substrate 1201.

The discharge electrodes 1206 and 1207 are arranged at predetermined intervals within the upper sidewalls 1208 in a substrate direction going from the front substrate 1201 to the barrier ribs 1205. The address electrodes 1203 are arranged to be spaced a predetermined distance from each of the discharge electrodes 1206 and 1207 in the substrate direction. The protective layer 1209 is formed on the upper sidewalls 1208 to protect the upper sidewalls 1208. The phosphor layers 1210 are formed by coating phosphor within the discharge cells 1220.

The upper sidewalls 1208 are formed of a dielectric material, and the discharge electrodes 1206 and 1207 and the address electrodes 1203 are all arranged within the upper sidewalls 1208. However, the present embodiment of the present invention is not limited by this exact structure of FIGS. 18 and 19 as the sequential order of these three electrode sets can vary. Further, it is possible to have one or more of the three electrode sets located on surfaces of the barrier ribs 1205 that face the discharge cells 1220 while the other remaining electrode sets remain embedded within the upper sidewalls 1208. Alternatively, all of these three electrode sets can be arranged within or on the barrier ribs 1205.

Each of the discharge electrodes 1206 and 1207 and the address electrodes 1203 can be arranged at predetermined intervals in a substrate direction going from the front substrate 1201 to the rear substrate 1202. The discharge electrodes 1206 correspond to Y electrodes, and the discharge electrodes 1207 correspond to X electrodes. The three electrode sets 1206, 1207, and 1203 are arranged within the upper sidewalls 1208 in a direction going from the front substrate 1201 to the rear substrate 1202, preferably in a sequence from the X electrodes 1207 to the address electrodes 1203 via the Y electrodes 1206. Further, it is preferable that each of the address electrodes 1203 are each split into two strands or prongs instead of one so that adjacent two discharge cells can be individually selected.

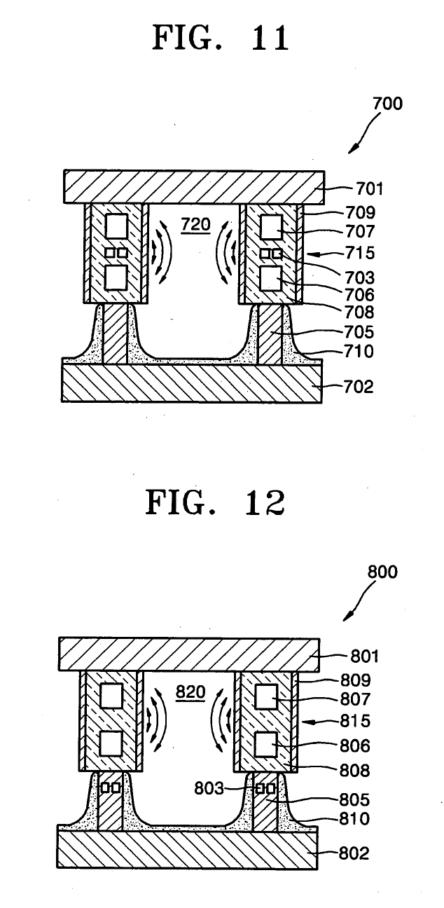

Another variation of the embodiment of FIGS. 18 and 19 is to have these three electrode sets arranged as illustrated in FIG. 10 where the address electrode 603, the Y electrode 606, and the X electrode 607 are sequentially arranged in the direction from the front substrate 601 to the rear substrate 602. Still another variation of the embodiment of FIGS. 18 and 19 is to have these three electrode sets arranged as illustrated in FIG. 11 where the X electrode 707 is placed closest to the front substrate 701, then the address electrode 703 and lastly the Y electrode 706 is located further from the front substrate 701 than either the address electrode 703 or the X electrode 707. In yet another variation of the embodiment of FIGS. 18 and 19, the relative positioning of these three electrode sets can be changed so that a Y electrode, an address electrode, and an X electrode are sequentially arranged.

While the present invention has been particularly illustrated and described with reference to exemplary embodiments thereof, it will be understood by those of ordinary skill in the art that various changes in form and details may be made therein without departing from the spirit and scope of the present invention as defined by the following claims.

What is claimed is:

1. A plasma display panel, comprising:
a front substrate and a rear substrate arranged at an interval to face each other;
a plurality of barrier ribs arranged between the front and the rear substrates, the plurality of barrier ribs being adapted to partition a space between the front and the rear substrates into a plurality of discharge cells, each of said plurality of discharge cells having one of a circular and an oval horizontal cross-section;
a plurality of discharge electrodes arranged at intervals on the plurality of barrier ribs in a substrate direction going from the front substrate to the rear substrate; and
a plurality of address electrodes arranged a distance apart from the plurality of discharge electrodes in the substrate direction.

2. The plasma display panel of claim 1, wherein the plurality of discharge electrodes and the plurality of address electrodes are arranged at intervals in the substrate direction.

3. The plasma display panel of claim 1, wherein the plurality of discharge electrodes and the plurality of address electrodes are arranged on surfaces of the plurality of barrier ribs that face the plurality of discharge cells.

4. The plasma display panel of claim 3, further comprising a dielectric layer coated over surfaces of the plurality of barrier ribs where the plurality of discharge electrodes and the plurality of address electrode are arranged, the dielectric layer being adapted to prevent charges from moving directly between the plurality of discharge electrode and the plurality of address electrodes.

5. The plasma display panel of claim 4, further comprising a protective layer arranged on the dielectric layer and adapted to protect the dielectric layer.

6. The plasma display panel of claim 1, wherein the plurality of discharge electrodes comprise:
a plurality of Y electrodes adapted to select ones of the plurality of discharge cells to emit light by producing an address discharge between the plurality of Y electrodes and the plurality of address electrodes; and
a plurality of X electrodes adapted to produce a sustain discharge between the plurality of Y electrodes and the plurality of X electrodes.

7. The plasma display panel of claim 6, wherein the plurality of X electrodes, the plurality of Y electrodes, and the plurality of address electrodes are sequentially arranged on surfaces of the plurality of barrier ribs that face the plurality of discharge cells the substrate direction.

8. The plasma display panel of claim 6, wherein the plurality of address electrodes, the plurality of Y electrodes, and the plurality of X electrodes are sequentially arranged in the substrate direction and on surfaces of the barrier ribs that face the discharge cells.

9. The plasma display panel of claim 6, wherein the plurality of X electrodes, the plurality of address electrodes, and the plurality of Y electrodes are sequentially arranged on surfaces of the plurality of barrier ribs that face the plurality of discharge cells in the substrate direction.

10. The plasma display panel of claim 6, wherein the plurality of Y electrodes, the plurality of address electrodes, and the plurality of X electrodes are sequentially arranged on surfaces of the plurality of barrier ribs that face the plurality of discharge cells in the substrate direction.

11. The plasma display panel of claim 1, further comprising a plurality of phosphor layers arranged within the discharge cells.

12. A plasma display panel, comprising:
a front substrate and a rear substrate arranged at an interval to face each other;
a plurality of barrier ribs arranged between the front and the rear substrates, the plurality of barrier ribs being adapted to partition a space between the front and the rear substrates into a plurality of discharge cells, each of the plurality of discharge cells having one of a circular and an oval cross-section;
a plurality of upper sidewalls extending from the plurality of barrier ribs towards the front substrate;
a plurality of discharge electrodes arranged at intervals and within the plurality of upper sidewalls, the plurality of discharge electrodes being arranged in a substrate direction going from the front substrate to the plurality of barrier ribs; and
a plurality of address electrodes arranged a distance apart from the plurality of discharge electrodes in the substrate direction.

13. The plasma display panel of claim 12, wherein the plurality of upper sidewalls comprise a dielectric material, the plurality of discharge electrodes being arranged within the upper sidewalls, the plasma display panel further comprising a protective layer arranged on the upper sidewalls and adapted to protect the plurality of upper sidewalls.

14. The plasma display panel of claim 12, the plurality of address electrodes being arranged within the plurality of upper sidewalls.

15. The plasma display panel of claim 12, wherein the plurality of discharge electrodes comprise:
a plurality of Y electrodes adapted to select ones of the plurality of discharge cells to emit light by producing an address discharge between the plurality of Y electrodes and the plurality of address electrodes; and
a plurality of X electrodes adapted to produce a sustain discharge between the plurality of Y electrodes and the plurality of X electrodes.

16. The plasma display panel of claim 15, wherein the plurality of X electrodes, the plurality of Y electrodes, and the plurality of address electrodes are sequentially arranged within the upper sidewalls and in the substrate direction.

17. The plasma display panel of claim 15, wherein the plurality of address electrodes, the plurality of Y electrodes, and the plurality of X electrodes are sequentially arranged within the upper sidewalls and in the substrate direction.

18. The plasma display panel of claim 15, wherein the plurality of X electrodes, the plurality of address electrodes, and the plurality of Y electrodes are sequentially arranged within the upper sidewalls and in the substrate direction.

19. The plasma display panel of claim 1 5, wherein the plurality of Y electrodes, the plurality of address electrodes, and the plurality of X electrodes are sequentially arranged within the upper sidewalls and in the substrate direction.

20. The plasma display panel of claim 12, further comprising a plurality of phosphor layers arranged within the plurality of discharge cells.
